(19) United States
(12) Patent Application Publication
(10) Pub. No.: US 2022/0371039 A1
(43) Pub. Date: Nov. 24, 2022

(54) SPRINKLER HEAD REPLACEMENT APPARATUS AND METHOD

(71) Applicant: Garton Earl Francis, Loxahatchee, FL (US)

(72) Inventor: Garton Earl Francis, Loxahatchee, FL (US)

(21) Appl. No.: 17/656,911

(22) Filed: Mar. 29, 2022

Related U.S. Application Data
(60) Provisional application No. 63/202,020, filed on May 24, 2021.

(51) Int. Cl. B05B 15/14; B05B 15/65

(52) U.S. Cl. CPC B05B 15/14; B05B 15/65

(57) ABSTRACT

A sprinkler housing assembly that defines a subterranean compartment to house the sprinkler head body, keeping it free from dirt and debris, yet safely below ground. The housing assembly has a peripherally sealed access opening through which an upper portion of the sprinkler head protrudes, thereby enabling the head to move between its inactive contracted position and its active extended position for watering the lawn. In the inactive contracted position, a user of the present invention may access the body of the sprinkler head in the enclosed compartment, to replace the entire sprinkler head, via an upper opening of the housing assembly, wherein the upper opening is adjacent or just downward to the groundlines. As a result, without digging and with only a screwdriver, the user may remove the entire sprinkler without ruining the lawn.

### CROSS-REFERENCE TO RELATED APPLICATION

This application claims the benefit of priority of U.S. provisional application No. 63/202,020, U.S. provisional application number filed 24 May 2021, the contents of which are herein incorporated by reference.

### BACKGROUND OF THE INVENTION

The present invention relates to irrigation systems, and more particularly, to an apparatus and method for sprinkler head replacement.

Replacing a sprinkler head installed in a lawn is a tedious task upon which most homeowners refuse to embark. Replacing the sprinkler head is a time-consuming process that may harm the homeowner's lawn.

Because the interface between the sprinkler head and the irrigation piping is below ground level and buried in dirt or debris, the only existing option for the task of replacing a sprinkler head is digging, which typically harms the lawn that the sprinkler system aims to nourish.

As can be seen, there is a need for an apparatus and method for sprinkler head replacement that eliminates digging and damaging the lawn, and as a result saves time. The apparatus and method of the present invention enables the user to replace a sprinkler head with a screwdriver, thereby causing no damage to the lawn and requiring no digging, while also saving time.

The present invention enables a sprinkler housing assembly that defines a subterranean compartment to house the sprinkler head body, keeping it free from dirt and debris, yet safely below ground. The housing assembly has a peripherally sealed access opening through which an upper portion of the sprinkler head protrudes, thereby enabling the head to move between its inactive contracted position and its active extended position for watering the lawn. In the inactive contracted position, a user of the present invention may access the body of the sprinkler head in the enclosed compartment, to replace the entire sprinkler head, via an upper opening of the housing assembly, wherein the upper opening is adjacent or just downward to the groundlines. As a result, without digging and with only a screwdriver, the user may remove the entire sprinkler without ruining the lawn.

### SUMMARY OF THE INVENTION

In one aspect of the present invention, a method of providing a subterranean compartment for a sprinkler head, the method including the following: defining the subterranean compartment by way of one or more sidewalls and an upper opening that communicates the subterranean compartment to an external environment; and removably attaching an access cover along an entirety of the upper opening, wherein an access opening is provided in the access cover, and wherein a peripheral seal defines the access opening; and further locating the upper opening at or just below a ground line; and further placing the sprinkler head in the subterranean compartment, wherein an upper portion of a body of the sprinkler head engages the peripheral seal.

In another aspect of the present invention, a sprinkler head apparatus includes the following: one or more sidewalls defining a compartment having an upper opening communicating to an external environment; an access cover removably connected along an entirety of the upper opening, wherein the access cover has an access opening; and a peripheral seal along a periphery of the access opening; and further including a bottom plate defining a bottom portion of the compartment, wherein the bottom plate has an inlet opposing the access opening; and further including at least one bottom seal, wherein each bottom seal has a hole concentric with the inlet; and further including a plurality of flanges disposed at or just downward of the upper opening, wherein the access cover removably connects to the plurality of flanges.

In yet another aspect of the present invention, a system for obviating digging of debris to access a subterranean portion of a sprinkler head provides the above-mentioned sprinkler head apparatus placed so that its upper opening is at or just downward of a groundline; and an upper portion of the sprinkler head protruding through the access opening wherein the peripheral seal engages the sprinkler head at or adjacent said upper portion, wherein an outlet of an irrigation conduit fluidly couples to said subterranean portion by way of the inlet.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the invention, shown in use in the ground 12.

FIG. 2 is a perspective view of an exemplary embodiment of the invention.

FIG. 3 is a section view of an exemplary embodiment taken along line 3-3 of FIG. 2.

FIG. 4 is an exploded perspective view of an exemplary embodiment of the invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a sprinkler head replacement apparatus and method. The present invention provides an apparatus and method which makes replacing a sprinkler head as easy as replacing a light bulb.

The present invention provides an effective and simple solution to the tedious task of replacing a sprinkler head installed in a lawn irrigation system. The present invention provides a solution to the time-consuming task of replacing a sprinkler head, and further permits the replacement of a sprinkler head without digging and thereby avoids causing damage to the lawn.

The apparatus and method of the present invention enables the user to replace a sprinkler head with a screwdriver, thereby causing no damage to the lawn and requiring no digging, while also saving time.

The apparatus and method may also be used in other applications. The apparatus may also be used as a marker and a housing for any items that may need to be buried to operate but require digging to repair or replace such items.

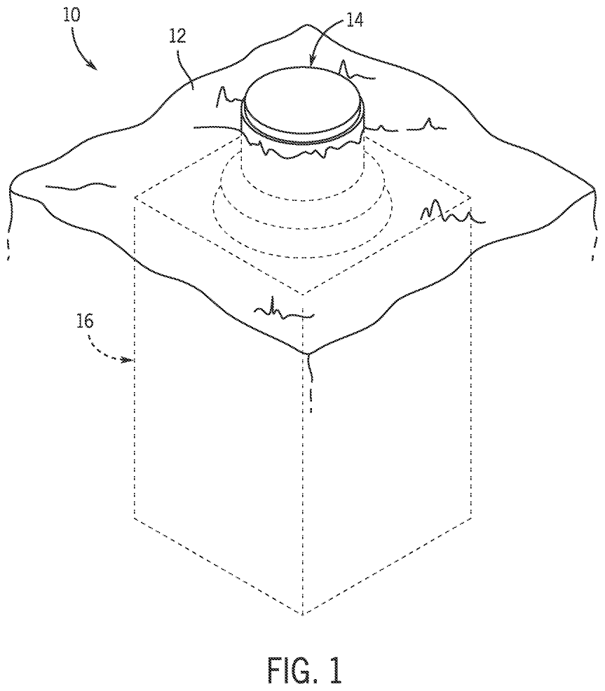

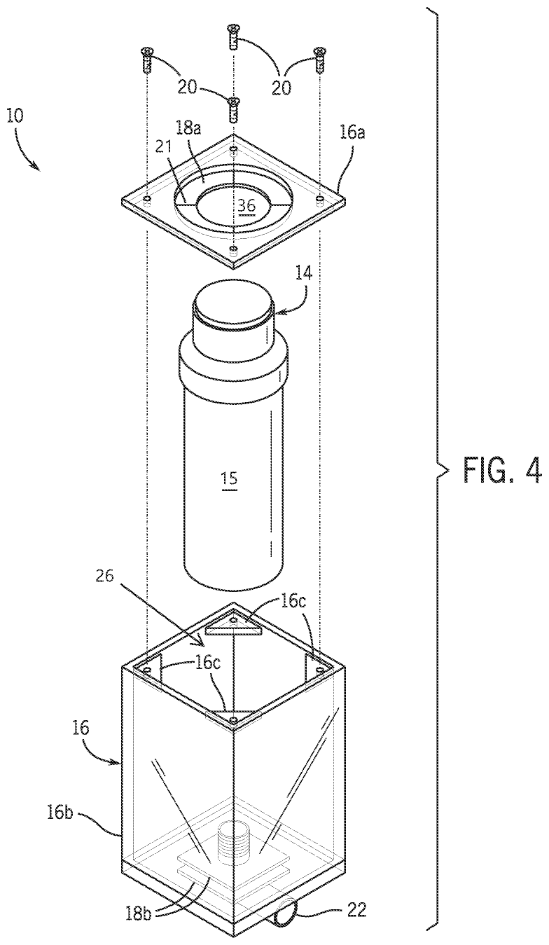

Referring now to FIGS. 1-4, the present invention may include a sprinkler head apparatus 10 configurable to engage an outlet 22 of an irrigation network of subterranean conduits. The sprinkler head apparatus 10 may include a subterranean housing assembly 16 defining a compartment dimensioned and adapted to receive a body 15 of a sprinkler head 14, wherein the subterranean housing assembly 16 also facilitates fluidly coupling the sprinkler head 14 to the outlet 22 of the irrigation network.

The subterranean housing assembly 16 may have a base 16b adapted to define the subterranean compartment dimensioned to receive a substantial portion of the sprinkler head 14. The base 16b may have one or more sidewalls 17b and a bottom plate 19 that define the subterranean compartment with an upper opening 26 in communication between the compartment and an external environment. The upper opening 26 may be at least partially covered by way of an access cover 16a.

The access cover 16a, the one or more sidewalls 17b and the bottom plate 19 may be made of transparent material or any material that enables the sprinkler head apparatus 10 to function as disclosed herein. The compartment may be cylindrical, rectangular or and any shape that houses a substantial portion of the sprinkler head 14 below ground 12.

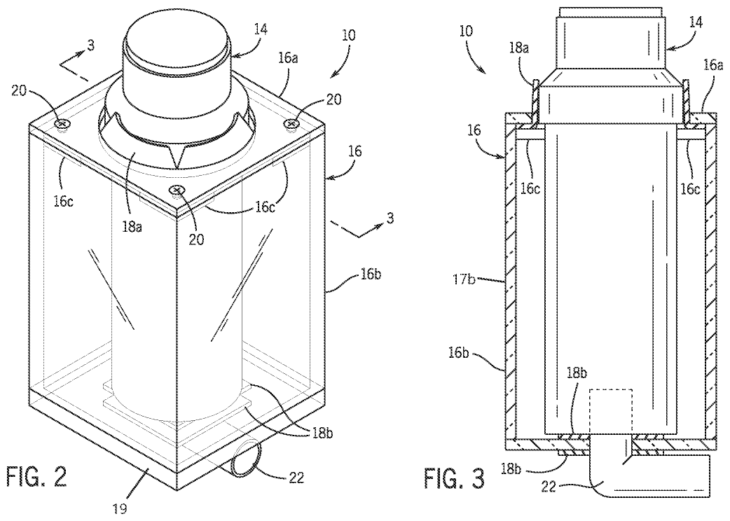

The access cover 16a may define an access opening 36 providing a peripheral seal 18a. The peripheral seal 18a is dimensioned and adapted to engage an upper portion of the body 15 (of the sprinkler head 14) protruding through the access opening, as illustrated in FIGS. 2 and 3. In this engaged state the peripheral seal 18a bends and deforms to conform to the protruding body 15, thereby engendering sealing properties between the body 15 and the access opening 36, preventing leakage of dirt or debris therebetween. The peripheral seal 18a may be made of sufficiently elastic and deformable material to facilitate the sealing properties against the protruding body 15.

The sidewalls 17b may provide internal flanges 16c at, adjacent to, and/or just downward of the upper opening 26 to support a removably connection between the access cover 16a and the base 16b by way of removable fasteners 20.

The bottom plate 19 may provide an inlet opening for receiving the outlet 22 of the irrigation piping. On both sides of the inlet opening may be seals 18b for providing sealing properties at the interface of the inlet opening and the outlet 22 that protrudes into the compartment to fluidly coupled to the sprinkler head 14. In some embodiments, the outlet 22 fluidly connects to the inlet opening (and does not protrude into the compartment) and by extension to the sprinkler head 14.

In an exemplary embodiment, the present invention may include one or more of the following elements or components and combinations thereof. Though other embodiments are contemplated that are functional equivalents to the below embodiment, wherein these functional equivalents have differently sized, shaped, materialled, etc. components.

### An Exemplary Embodiment

1. Four each of approximately 4″×6″ material; nonlimiting examples of which may include plexiglass, aluminum, rubber or the like.

2. Four each triangular approximately one-inch in diameter from same material.

3. Two each approximately 4″×4″ material, nonlimiting examples of which may include plexiglass, aluminum, rubber, or the like.

4. Four each 3-32nd screws.

5. Bonding material, such as, for example without limitation, glue, solder, or welding material.

6. One each 3⅛″×3⅛″ durable rubber.

7. Two each 2″×2″ durable rubber.

In the exemplary embodiment the elements or components may interrelate in the following manner.

1. The approximately 4″×6″ materials may be bonded together by adhesive, solder, or welding to create a rectangular casing.

2. The triangular pieces of materials may be used at the top to secure the access cover.

3. One of the approximately 4″×4″ material may be used for the access cover 16a.

3. One of the approximately 4″×4″ material may be used for the bottom plate 19 with an access hole for the approximately ¼″ sprinkle elbow.

4. Four 3-32nd screws may be used to secure the access cover.

5. Adhesive, solder, or welding may be used to bond the 4′×6″ materials together.

6. Three approximately ⅛″×3⅛″ durable rubber may be placed on the access cover to prevent large debris from falling in the device, and secondarily to secure the sprinkler head in the device.

7. The approximately 2″×2″ durable rubber may be used to secure the pipe elbow in the bottom of the device.

In one of many embodiments, the present invention may work in the following manner. Upon initial installation of a sprinkler system or replacement of a sprinkler head 14, the sprinkler head apparatus 10 may be placed in the ground 12, subterranean, wherein the ground 12 will hold it in place. The user may then install the housing assembly 16 by threading the outlet 22 piping through or to the bottom plate 19. Then the user may then install the sprinkler head 14 inside the housing assembly 16 compartment via the upper opening 26. The access cover 16a may then be removably joined to the upper opening 26 so that an upper portion of the body 15 (e.g., the ‘shoulders’ of the body 15) of the sprinkler head 14 protrude through the peripheral seal 18a of the access opening 36, thereby preventing debris from getting into the compartment. The access opening 36 may be approximately three inches in diameter to further enable the sprinkler head 14 to raise and lower in use. The peripheral seal 18a may have slots or perforations 21 cut in it to further allow the sprinkler head 14 to rise and fall without obstruction. The material, dimensions, and perforations 21 of the peripheral seal 18a also provide additional pressure to secure the sprinkler head 14 in the housing assembly 16.

The sprinkler head apparatus 10 of the present invention and its components may be made of any suitable material and may be fabricated by any suitable process. In an exemplary embodiment the apparatus may be made of materials described herein, by a method described herein.

In an exemplary embodiment, once the materials are procured, they may be cut to a size and formed into the sprinkler head apparatus 10. Alternatively, the sprinkler head apparatus 10 may be manufactured through additive printing or injection molding. Depending on the material used and the manufacturing process, the materials may be bonded together with glue, solder, or weld. For instance, the seals 18a and 18b may then be glued in place.

A method of manufacturing the present invention for one embodiment may include the following:

A manufacturer may drill four-inch hole with a 3/32 drill bit in the top access cover for the retaining screws. The manufacturer may cut a ⅞ hole in the bottom 4×4 plate 12 to allow access to the ¾ threaded elbow/outlet 22. The manufacturer may glue the 2″×2″ durable rubber over the hole and then cut two each ½″ slits 21 to allow installation of the threaded elbow/outlet 22, and these bottom seals 18b also hold the outlet 22 securely in-place. The manufacturer may attach the 4×1″ triangular flanges 16c, one each in each corner at the top of the 4×6 casing. The manufacturer may drill one 3-32″ hole in each triangle piece ensuring they are in perfect alignment with the 3-32 holes drilled in the top access cover. In some embodiments, instead of using the rectangular design, one could make this device in a different shape.

In an exemplary embodiment all these described components are necessary.

In an exemplary embodiment the present invention may be used in the following manner. The present invention may be used with only a screwdriver to replace or repair a sprinkler head. Formerly, previous solutions to replace or repair a sprinkler head required digging a hole with a one to two feet diameter and minimum six inches deep which usually requires some tools, such as a shovel, a hoe, and/or a pick, as well as a container to hold dirt and in most cases new grass seeds. The apparatus of the present invention permits the user to complete the task of replacing or repairing a sprinkler head with only a screwdriver, thereby saving the user valuable time, money, and effort. The subterranean compartment affords the user an dirt/debris-free space to change the sprinkler head 14, wherein the housing assembly 16 is adapted to prevent dirt/debris from getting into this compartment. In short, the sprinkler head apparatus 10 of the present invention permits the user to complete the task of replacing or repairing a sprinkler head 14 using only a screwdriver to remove the plurality of fastener 20 to remove the access cover 16a to repair or replace the sprinkler head 14. No moving of dirt or debris is required.

The present invention may be applicable to a wide range of other uses. The apparatus of the present invention may be used as a marker and housing for any item that needs to be buried to operate but requires digging to repair or replace said item.

In summary, the present invention provides an apparatus and method for use in repairing or replacing an installed lawn sprinkler head. The apparatus of the present invention makes replacing a sprinkler head as easy as replacing a light bulb. The apparatus of the present invention improves on the process of replacing or repairing a lawn sprinkler head by eliminating digging and damaging the user's lawn, as well as saving time.

For clarity, only those aspects of the system germane to the invention are described, and product details well known in the art may be omitted. In addition, many embodiments of the present invention have application to a wide range of industries. To the extent the present application discloses a system, the method implemented by that system is within the scope of the present invention. Further, to the extent the present application discloses a method, a system of apparatuses configured to implement the method are within the scope of the present invention.

As used in this application, the term “about” or “approximately” refers to a range of values within plus or minus 10% of the specified number. And the term “substantially” refers to up to 90% or more of an entirety. Otherwise, the words “about,” “approximately,” or the like, when accompanying a numerical value, are to be construed as indicating a deviation as would be appreciated by one of ordinary skill in the art to operate satisfactorily for an intended purpose.

Recitation of ranges of values herein are not intended to be limiting, referring instead individually to any and all values falling within the range, unless otherwise indicated, and each separate value within such a range is incorporated into the specification as if it were individually recited herein. Otherwise, ranges of values and/or numeric values are provided herein as examples only, and do not constitute a limitation on the scope of the described embodiments.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary. The directional terms such as “upper” and “bottom” and their equivalents are defined in relationship to the accompanying Figures, wherein “upper” is directed toward the top margin of the Figures, while the term “bottom” are directed toward the bottom margin of the Figures.

It should be understood, of course, that the foregoing relates to exemplary embodiments of the invention and that modifications may be made without departing from the spirit and scope of the invention as set forth in the following claims.

What is claimed is:

1. A method of providing a subterranean compartment for a sprinkler head, the method comprising:
defining the subterranean compartment by way of one or more sidewalls and an upper opening that communicates the subterranean compartment to an external environment; and
removably attaching an access cover along an entirety of the upper opening, wherein an access opening is provided in the access cover, and wherein a peripheral seal defines the access opening.

2. The method of claim 1, further locating the upper opening at or just below a ground line.

3. The method of claim 2, further placing the sprinkler head in the subterranean compartment, wherein an upper portion of a body of the sprinkler head engages the peripheral seal.

4. A sprinkler head apparatus comprising:
one or more sidewalls defining a compartment having an upper opening communicating to an external environment;
an access cover removably connected along an entirety of the upper opening, wherein the access cover has an access opening; and
a peripheral seal along a periphery of the access opening.

5. The sprinkler head apparatus of claim 4, further comprising a bottom plate defining a bottom portion of the compartment, wherein the bottom plate has an inlet opposing the access opening.

6. The sprinkler head apparatus of claim 5, further comprising at least one bottom seal, wherein each bottom seal has a hole concentric with the inlet.

7. The sprinkler head apparatus of claim 6, further comprising a plurality of flanges disposed at or just downward of the upper opening, wherein the access cover removably connects to the plurality of flanges.

8. A system for obviating digging of debris to access a subterranean portion of a sprinkler head, the system comprising:
the sprinkler head apparatus of claim 5 placed so that its upper opening is at or just downward of a groundline; and
an upper portion of the sprinkler head protruding through the access opening wherein the peripheral seal engages the sprinkler head at or adjacent said upper portion.

9. The system of claim 8, wherein an outlet of an irrigation conduit fluidly couples to said subterranean portion by way of the inlet.
